(19) United States
(12) Patent Application Publication
(10) Pub. No.: US 2025/0052664 A1
(43) Pub. Date: Feb. 13, 2025

(54) METHOD AND SYSTEM FOR VISUALIZATION OF THE STRUCTURE OF BIOLOGICAL CELLS

(71) Applicant: RAMOT AT TEL-AVIV UNIVERSITY LTD., Tel Aviv (IL)

(72) Inventor: Natan Tzvi SHAKED, Tel Aviv (IL)

(21) Appl. No.: 18/717,651

(22) PCT Filed: Dec. 14, 2022
(86) PCT No.: PCT/IL2022/051324

§ 371 Date: Jun. 7, 2024

Related U.S. Application Data
(60) Provisional application No. 63/292,167, filed on Dec. 21, 2021.

(51) Int. Cl. G01N 15/14; G01N 15/10; G01N 15/1434; G03H 1/00; G03H 1/04; G06V 10/82

(52) U.S. Cl. CPC G01N 15/1459; G03H 1/0443; G06V 10/82; G01N 2015/1006; G01N 2015/1454; G03H 2001/005; G03H 2210/62

(57) ABSTRACT

Some embodiments relate to a data analysis system is presented for inspecting unstained biological cells during fast flow. The data analysis system comprises: a data input utility, and data processor. The data input utility receives raw measured data comprising measured data pieces corresponding to a stream of raw data containing wavefront acquisitions collected from said unstained biological cell under inspection being obtained from the unstained biological cell during the fast flow. The data processor and analyzer is configured and operable to apply to said raw measured data real time processing by a trained neural network model and extract cell-related data.

### CROSS-REFERENCE TO RELATED APPLICATIONS

This application is a national phase filing under 35 C.F.R. § 371 of and claims priority to PCT Patent Application No. PCT/IL2022/051324, filed on Dec. 14, 2022, which claims the priority benefit under 35 U.S.C. § 119 of U.S. Patent Application No. 63/292,167, filed on Dec. 21, 2021, the contents of each of which are hereby incorporated in their entireties by reference.

### TECHNOLOGICAL FIELD AND BACKGROUND

The presently disclosed subject matter is generally in the field of biological cell visualization and relates specifically to biological cell flow cytometry with imaging capabilities.

Optical imaging is a central aspect not only of biological research, but also of biomedical examination and medical diagnosis. For example, red blood cells have a crucial role in the health of the human body. Blood analysis is used as the first diagnosis and monitoring tool for many pathological conditions. An accurate information about the full 3D structure and the content of blood cells is of vital importance for human health. Optical microscopic analysis of chemically stained blood smears has been used for diagnosis for almost 120 years. This analysis is typically done manually under a light microscope, and is laborious and subjective, providing very low throughput (number of cells analyzed per unit time).

In the modern clinical lab, flow cytometry (FC) is first used for initial inspection, automatically providing a scatter plot for the blood cell types, and microscopic inspection is typically performed in the end of the process, for visual verification and for obtaining decisions in borderline cases. FC is able to analyze a large number of cells during rapid flow.

The global market size of flow cytometry (FC) is estimated as USD 3.29 Billion in 2017, and projected to reach USD 4.79 Billion by 2022. This rapid growth is mainly attributed to the anticipation that FC should growingly become a more common direct clinical instrument in medical centers that cannot afford it now. In parallel, there is an increasing incidence and prevalence of different pathological cell conditions that can be characterized and monitored by FC, such as cancer and various chronic diseases, consistently resulting in the growing adoption of FC in advanced research activities and clinical trials, even in emerging countries. Rising implementation of microfluidic miniature FC in point-of-care diagnostics is another factor augmenting the domain growth. Technology advancements for cost-effectiveness, portability and enhanced accuracy are expected to serve this market with profitable growth opportunities. Now, however, many clinical research laboratories and specialized clinics find it difficult to afford FC due to a restricted budget, which hinders the wide adoption of FC in both clinical and research applications.

### GENERAL DESCRIPTION

There is a need in the art for a novel approach for inspection of biological cells during fast flow, enabling inspection of stained and unstained biological cells.

Cellular morphology analysis plays an important role in various clinical diagnoses. Imaging Flow Cytometry (IFC) can incorporate imaging capabilities in FC, providing a more comprehensive analysis by presenting a detailed morphological structure image of individual cells. Erroneous analysis results, yielded in conventional FC, can be eliminated by acquiring and analyzing such cell images by distinguishing between cells, debris, and clusters of cells. While conventional FC measures the integral intensity of fluorescent emission, fluorescence imaging is able to yield the exact morphology of the cell and its organelles. Recent advances in imaging technologies, as well as the exponentially evolving computational capacity, have enabled IFC by integrating fluorescence microscopy and conventional FC.

However, current IFC machines are very expensive (>Euro 0.7M), and out of reach of clinical use, despite their tremendous diagnosis potential. To capture images of the same cells, with numerous fluorescent labels per each cell, the realization of current IFC requires a serially disposed laser towers, complicated spectral separation filters, and expensive cameras that image the same cell in multiple fluorescent imaging channels on different locations on the camera, necessitating cameras with many pixels, complicated calibration, and extensive digital processing to avoid image registration problem.

Moreover, since IFC can typically produce thousands of multi-spectral cell images per second, files generated by IFC can tremendously burden the digital image transportation and processing. For example, a throughput of 5,000 cells per second might easily produce more than 100 GB of data within a few minutes of acquisition. To integrate actual cell sorting, rather than just counting, to fully realize IFC potential, real-time image reconstruction and analysis are required, necessitating a high-price processing unit. Furthermore, even if offline processing is allowed, the detecting of rare events using IFC, such as the presence of circulating tumors cells (CTCs) in blood, can take a very long time of processing. Thus, the use of multiple imaging channels to obtain a morphological image, with multiple cell organelles labelled, makes the current IFC machines very complex and expensive.

Since isolated biological cells are mostly transparent under light microscopy, typical IFC evaluates cellular features by using fluorescent markers. However, using numerous fluorescent morphological labels might affect the cell viability or behavior and negate further processing. In addition, suitable markers might not be available or allowed for certain cell types or organelles. Moreover, fluorescent markers tend to photobleach, which damages the image contrast and the prognosis results. As a result, the current-generation IFC remains clinically inaccessible technology, due to its cost, requirement for operator expertise, lack of accuracy, and lack of objectiveness of data produced.

Tomography can yield 3D biological cell reconstruction by capturing 2D images of the cell perspective projections. Specifically, tomographic phase microscopy allows 3D refractive-index (RI) reconstruction of biological cells by acquiring their interferometric projections, allowing visualizing them in 3D without chemically staining the cells. The problem is that tomography requires knowledge on the viewing angle in each projection, as well as a very heavy computational process. This is not suitable for imaging flow cytometry of biological cells, which requires very high throughput (imaging thousands of cells per second). The cells can be rotated during flow for imaging their projections, but the viewing angle is not exactly known, also it is not possible to calculate the 3D image fast enough. The 3D reconstruction requires collection of many perspective interferometric projections, and processing all of them with a very heavy computational process, which is far away from real-time implementation.

The technique of the present disclosure provides an innovative approach for inspection of biological cells during fast flow, enabling inspection of stained or unstained biological cells. This technique is based on 3D imaging flow cytometry (3D-IFC) processing, which utilizes stain-free wavefront acquisition and special data analysis based on artificial intelligence (AI), i.e., machine learning methods based on artificial neural networks.

Specifically, the technique of the present disclosure provides a solution to clinical 3D-IFC based on collection of cellular deep data (e.g., 3D cell structure and cell contents) from live cells during rapid flow and analysis based on deep learning algorithms for 2D/3D virtual staining, as well as for automatic cell classification, making the cells look as though they have been chemically stained, but without using chemical staining, and detecting their types (i.e. classifying) even without 3D visualization.

This technique utilizes machine learning methods based on artificial neural networks, e.g., a deep-learning framework, to convert raw image data, acquired by a detector array (camera) for wavefront sensing (e.g., digital holograms) from biological cells during fast flow thereof, directly into the 2D virtually stained images, and/or to convert the raw-data holographic projections (collected from rotating biological cells during the fast flow) directly into the 3D virtual stained profiles of biological cells, sparing the entire typical heavy computational process. It is relevant for real-time classification and/or visualization in IFC, where the processing is done on the raw image data acquired by the camera.

It should be noted that the imaging technique of the present disclosure, while being applied to cells during fast flow of the cells, is capable of utilizing raw measured data indicative of a stream/sequence of wavefront recordings/acquisitions (e.g., digital holograms), directly obtained from the flowing cells. Such raw measured data can be analyzed using properly trained machine-learning model.

More specifically, the technique of the present disclosure provides a novel approach for tomography, using a trained neural network for translating digital hologram data of the flowing cell (while ignoring interference spatial-frequency or other distracting details) into cell-related data, e.g. class type of the cell and/or 3D image of the cell.

In the description below, the technique of the present disclosure is exemplified as utilizing deep learning methods based on deep neural networks (DNNs). However, it should be understood that, generally, the principles of the technique of the present disclosure can be implemented using any machine learning methods based on artificial neural networks, where deep learning is an example of such machine learning approach. Examples of suitable DNNs include: long short-term memory (LSTM), recurrent neural network (RNN), gated recurrent unit (GRU), etc.

The DNN may utilize a decoder neural network (such as generative adversarial network (GAN)).

The neural networks can be properly trained offline. For example, in order to extract 3D structure of the cell, the neural network can be trained by providing pairs of projection videos and 3D images of cells. Inference (running the trained networks) can be done in real-time by using a graphic card sitting close to the camera, thus directly presenting the cell-related data (e.g. 3D image of the cell) during its flow. This technique may be helpful for clinical diagnosis based on analysis of cells in liquid biopsies.

Thus, according to one broad aspect of the technique of the present disclosure, it provides a data analysis system for inspecting a biological cell during fast flow of the cell. The data analysis system comprises: a data input utility configured and operable to receive raw measured data comprising measured data pieces corresponding to a stream of wavefront acquisitions collected from the biological cell; and a data processor and analyzer configured and operable to apply, to said raw measured data, real time processing by a trained neural network model and directly extract cell-related data.

The raw measured data may comprise the data pieces corresponding to the stream of digital holograms.

The cell-related data may include a cell type, enabling direct classification of the cell based on the analysis of the raw measured data.

In some embodiments, the inspection is performed on rotating cells during fast flow thereof (giving access to the cell perspective projections). Such rotation might naturally occur during the fast flow. In these embodiments, the cell-related data that can be directly extracted from the dynamically obtained (video) of digital holograms, and is indicative of three-dimensional structure and contents of the cell, thereby enabling direct visualization of the biological cell.

The data analysis system may be configured for data communication with a storage device to access the trained neural network prepared by processing raw measured data comprising wavefront acquisitions collected from a similar biological cell while during the fast flow and corresponding cell-related data. The corresponding cell-related data may comprise 3D refractive index images of the cell.

The trained neural network model may be configured to implement a convolution neural network (CNN) functionality.

The technique of the present disclosure thus provides for extracting cell-related data indicative of three-dimensional structure and contents of the cell, and/or its classification state (type, pathological state), with minimal or no prior processing of the raw measured data acquired directly by the detector array (without a need for extracting the quantitative phase profile of the cell, as is needed in the conventional computational approaches), as well as without first visualizing the cell.

As indicated above, in some embodiments, the system is configured for data communication with a storage device to access the trained neural network previously prepared by processing raw measured data comprising wavefront acquisitions collected from similar biological cell(s) during the fast flow. In some embodiments, training of the neural network also utilizes corresponding 3D refractive index images of the cell (obtained via full OPD-based reconstruction of the wavefront acquisitions).

According to another aspect of the technique of the present disclosure, it provides a 3D IFC system comprising: an imaging module configured and operable to provide measured data indicative of wavefront acquisitions (e.g., digital holograms), and the above-described data analysis system.

According to yet another broad aspect of the technique of the present disclosure, it provides a method for inspecting a biological cell during fast flow, the method comprising:
providing at least one trained neural network configured for translating a stream of measured data pieces corresponding to wavefront acquisitions (e.g., digital holograms) of a flowing (and possibly rotating) biological cell into cell-related data indicative of at least one of the cell type and a 3D image of the cell;
providing input data comprising raw measured data in the form of data pieces corresponding to a stream of wavefront acquisitions of the biological cell under inspection being obtained from said biological cell during the fast flow thereof; and performing real time processing of said raw measured data by accessing said at least one trained neural network and applying to said raw measured data a corresponding trained neural network model and extracting the cell-related data.

In the description below wavefront recordings/acquisitions are referred to as holograms or digital holograms. It should, however, be understood that this term should be interpreted broadly covering also other similar techniques of wavefront acquisitions. Furthermore, in the description below, the machine learning based data analysis is exemplified as using encoder-decoder architecture, while it should be understood that other learning mapping methods (which are not encoder-decoder based) can also be used to implement the principles of the technique of the present disclosure.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 exemplifies the known process of 3D visualization of biological cells;

FIG. 2 is a flow diagram exemplifying the technique of the present disclosure for reconstructing the structure and contents of biological cells;

FIG. 3 is a flow diagram exemplifying the training of the neural network according to the technique of the present disclosure;

FIG. 4 is a flow diagram exemplifying the technique of the present disclosure for determining types of the biological cells, thereby enabling classification of the cells being inspected; and

FIG. 5 is a schematic diagram of a novel imaging flow cytometry device according to the technique of the present disclosure.

### DETAILED DESCRIPTION OF EMBODIMENTS

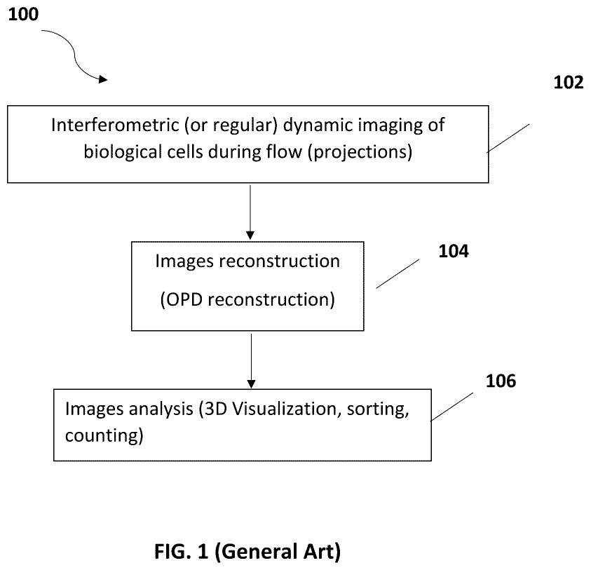

Referring to FIG. 1, there is illustrated a flow diagram 100 of the typical process of 3D visualization of biological cells based on label-free tomographic phase microscopy. The cells during flow undergo dynamic interferometric imaging (step 102). The so-obtained image data is processed by optical path delay (OPD)-based reconstruction technique (step 104) enabling further image analysis of the cells' structure for the purposes of visualization, sorting, counting, etc. (step 106).

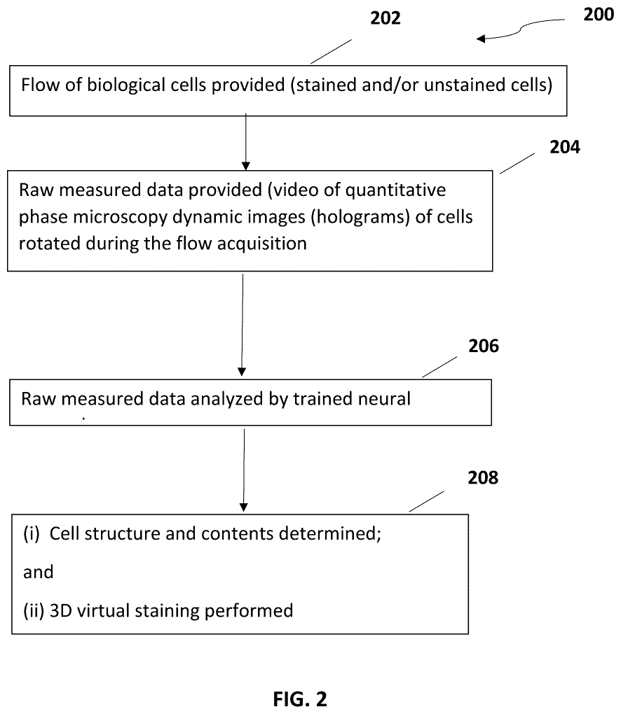

FIG. 2 exemplifies a flow diagram 200 exemplifying the technique of the present disclosure for inspecting biological cells to extract cell-related data. In the non-limiting example of FIG. 2, the technique is used for reconstructing the 3D structure and contents of biological cells. The technique concerns processing of raw measured data (step 204) obtained from the flow of unstained biological cells (provided in step 202). The raw measured data includes raw image data pieces indicative of dynamically obtained (video of) digital holograms of the biological cells while being rotated during a fast flow (e.g., while flowing through a microchannel).

The raw measured data is obtained by using any suitable IFC system enabling fast flow of the cells and a measurement device including any known suitable imaging system for wavefront acquisitions/recordings (e.g. digital holographic imaging system). The construction and configuration of the flow cytometry as well as the measurement device are known per se and do not form part of the present disclosure and therefore need not be described in details.

For example, the flow cytometer may be configured and operable as described in “Tomographic flow cytometry by digital holography”, Francesco Merola et al., Light: Science and Applications, 2017, 6, e16241; an example of the suitable quantitative phase microscopy measurement device is described in U.S. Pat. No. 11,125,686 assigned to the assignee of the present application.

The raw measured data to be analyzed may be provided directly from the measurement system, or from an external storage device where such measured data is pre-stored.

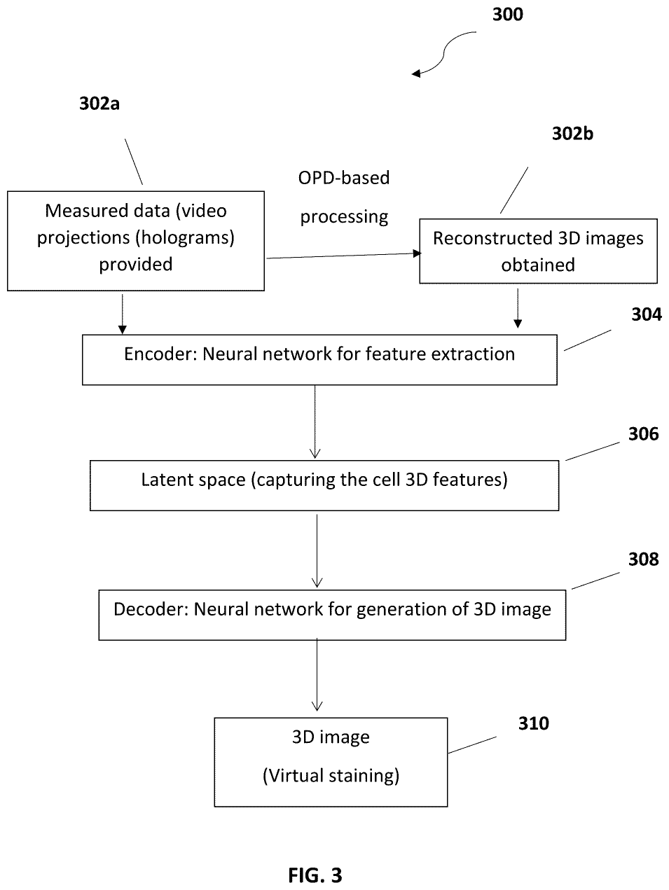

The raw measured data (sequence of perspective holograms corresponding to various 3D orientations of the cell) is then analyzed by a trained deep neural network analyzer (step 206). The training stage (which is performed once) is exemplified in FIG. 3.

The data analysis provides for direct determination of cell-related data such as the cell structure and contents and, accordingly, allows to perform virtual staining (step 208). The direct determination of such parameters eliminates a need for OPD profile reconstruction from the measured data, while providing accurate scatter plot for the cell counting, which is based on the quantitative cell structural and contents imaging data, as well as 3D image representing each cell, in which the cell looks as though it has been chemically stained, but without using chemical staining. The cell-related data that can be obtained from the data analysis include refractive index map of the cell structure and/or 3D virtually stained image of the cell.

Referring to FIG. 3, there is exemplified a flow diagram 300 of the process of neural network training suitable to be used in the technique of the present disclosure to determine/build a machine learning model. Generally, the neural networks (e.g., deep neural networks) can be trained offline.

An exemplary deep neural network (DNN) utilizes an encoder and a decoder. The encoder receives multiple pairs of video projections (raw measured data pieces) obtained in step 302a and corresponding 3D images of the cell (obtained via full OPD-based reconstruction of said video projections) in step 302b, and uses the entire input data to perform feature extraction (step 304) and map the video of the flowing cell into the latent space (ignoring interference spatial-frequency or other distracting details), where the captured 3D features of the cell are represented by compressed data (similar data points are closer together in space)—step 306. The decoder analyzes those features in relation to the video projections and determines a machine learning model (step 308). The DNN encoder and decoder operate together to minimize the loss between the original data (measured data) and reconstructed data.

The machine learning model defines the trained neural network functionality (inference) to generate reconstructed 3D image data of the cell from the raw measured data (step 310).

For example, the training encoder DNN may be configured as Long Short-Term Memory (LSTM), Recurrent Neural Network (RNN), Gated Recurrent Unit (GRU), etc.); and the decoder neural network may be configured as Generative Adversarial Network (GAN)). The latent space being used is configured to build the 3D image by the predetermined decoder.

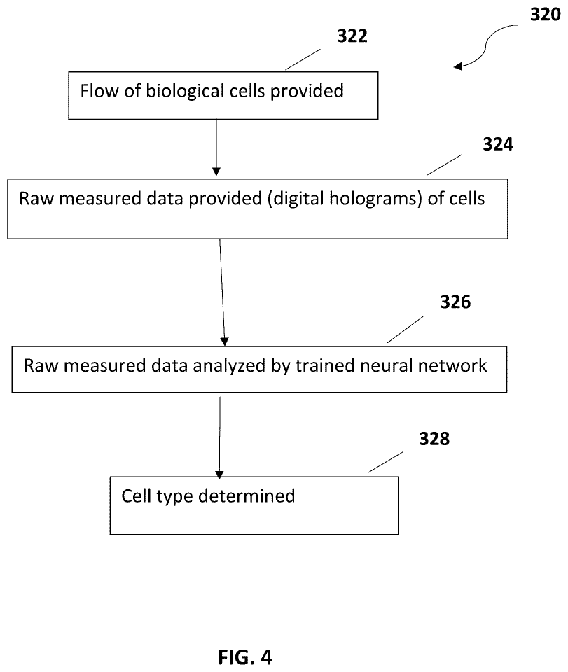

Reference is now made to FIG. 4 showing a flow diagram 320 exemplifying the technique of the presently disclosed subject matter for determining types of the biological cells, enabling classification of the cells being inspected. The flow of unstained cells is provided (step 322) and subjected to holography imaging, to obtain raw measured data (digital holograms) of the cells (step 324). The raw measured data is analyzed (while avoiding analysis of the spatial frequency of the holograms) by using trained neural network (step 326), i.e., machine learning model defining the trained neural network inference to generate reconstructed 3D image data of the cell from the raw measured data (digital holograms). The neural network is trained to translate the digital holograms of the cell into the cell type to thereby enable classification of the cell (step 328).

For example, I inference stage of the data analysis, i.e., running the trained DNN, to obtain virtual staining and classification of the cells, is implemented by applying a convolutional neural network (CNN) directly on the raw holograms. The result is a scatter plot containing clusters of the cell types, obtained from the label-free structural imaging approach described above.

Since the raw holograms are used directly for classification, without OPD reconstruction of each hologram, the inference (actual classification after the network is trained) can be done in real time, during the cell flow, allowing analysis in higher throughputs of thousands of cells per second.

It should be understood that the technique of the present disclosure provides a novel data analysis system, which is generally a computer system configured to be in data communication with a measurement system of the kind comprising a digital holographic imaging system (generally, wavefront acquisition system). Such computer system includes inter alia data input/output utilities, memory and data processor, where the data processor in configured to implement in real time the above-described inference stage of the analysis of raw measured data in the form of digital holograms (in some embodiments, holographic video) measured on cells during their fast flow. As also described above, the inference stage utilizes the trained neural network, where the training is performed once for certain type of cells (e.g. offline) and the trained neural network is properly kept in a storage device. Such data analysis system may be integral with the measurement module.

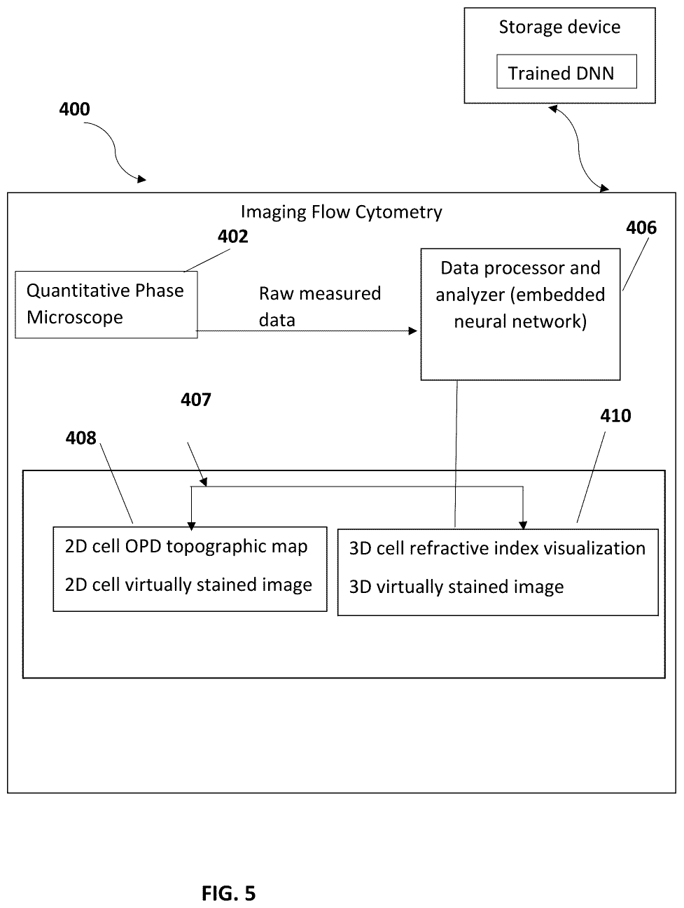

FIG. 5 exemplifies, by way of a block diagram, an integrated IFC system 400 of the presently disclosed subject matter including a measurement system/module (quantitative phase microscope) 402 and the processor and analyzer utility 406. The measurement module 402 is applied to the cell while in a flow cytometer (not shown here) and produces the raw measured data (raw digital holograms data) of the unstained (i.e. unlabeled) biological cells during fast flow.

It should be understood that the data processor and analyzer 406 is configured according to the technique of the present disclosure, and therefore, after training and testing (as described above with reference to FIG. 3), it includes robust neural networks with all available computational power as an embedded machine learning hardware. Therefore, such analyzer 406 can be configured as a graphic card and can be placed close to or be integral with the camera 402 and enables execution (inference) of the trained neural networks (obtained from a storage device) without using an external computer, thereby facilitating real-time processing. Thus, in this case, the long training process of the network will not take place on the embedded device, but rather only the inference.

Convolutional neural networks (CNNs) might be preferred for inference due to lower power consumption and fewer weights compared to other networks. Data compression, quantization, and removal of parts of the trained network that have only small effects on the result (pruning) might be needed to further save resources when running the trained network (inference). Then, compact machine-learning processing boards with camera modules (such as the embedded-vision development and processing kits from Basler, Germany) may be used.

As described above, the data analysis provides for direct determination of various types of cell-related data. The system 400 includes a data presentation utility 407 which present the analysis results, such as 2D cell OPD topographic map and 2D cell virtually stained image (408) and/or 3D cell refractive index visualization and 3D virtually stained image (410).

Virtual staining and classification of cells, according to the technique of the present disclosure, is obtained by using a machine-learning platform that processes the raw interferometric projections of cells during flow. No complex-wavefront processing and positioning in the 3D Fourier spectrum are required for tomography or for classification, and moreover, there is no need to know the viewing angle during cell's flow (and possibly rotation during the flow). Thus, the neural network approach is used to ease the processing complexity in tomographic phase microscopy for rapid 3D visualization and cell classification.

The technique of the present disclosure can be used in various applications, including but not limited to blood analysis, specifically, detection of haematological disorders via the acquisition of red blood cells and various types of white cells. In the clinical lab, the device based on the principles of the technique of the present disclosure, may be placed after the initial blood analyser machine, and before performing blood smear and imaging-based inspection. The device of the technique of the present disclosure can operate in cases of flags raised by the initial blood analyser machine due to overlaps between populations of cells in the scatter plot and eliminates or at least significantly reduces the need for visual smear inspection or additional and significantly more expensive FC with specific antibodies. This device can implement quantitative phase imaging, cell-type classification, and 2D or 3D virtual staining of cells during flow, at rates of up to several thousands of cells per second, at 4-5 orders of magnitude faster rates than possible via optical smear imaging. This is possible since the AI processing (inference) can be done directly on the raw holograms as acquired by the camera without wavefront or OPD profile extraction first. The technique of the present disclosure is expected to provide a more accurate scatter plot for cell counting, which is based on the quantitative cell structural and contents imaging data, as well as 3D image representing each cell, in which the cell looks as though it has been chemically stained, but without using chemical staining.

The same technology of 3D IFC for stain-free cell analysis provided by the present disclosure can be used in various other fields. These include urine analysis, sperm selection for in-vitro fertilization (IVF), rare-cell isolation from liquid biopsies (such as circulating tumour cells (CTCs) and stem cells) and others.

1. A data analysis system for inspecting biological cells during fast flow, the system comprising:
a data input utility configured and operable for receiving raw measured data comprising measured data pieces corresponding to a stream of raw data containing wavefront acquisitions collected from said biological cell under inspection being obtained from the biological cell during the fast flow;
a data processor and analyzer configured and operable to apply to said raw measured data real time processing by a trained neural network model and extract cell-related data.

2. The system according to claim 1, wherein said raw measured data comprises the data pieces corresponding to the stream of digital holograms.

3. The system according to claim 1, wherein the cell-related data includes a cell type, enabling direct classification of the cell based on the analysis of the raw measured data.

4. The system according to claim 1, wherein the cell-related data extracted from the raw measured data collected from a rotating biological cell being inspected during the fast flow is indicative of a three-dimensional structure of the biological cell and contents of said biological cell, thereby enabling direct visualization of the biological cell.

5. The system according to claim 1, configured for data communication with a storage device to access the trained neural network prepared by processing raw measured data comprising wavefront acquisitions collected from a similar biological cell while during the fast flow and corresponding cell-related data.

6. The system according to claim 5, wherein said corresponding cell-related data comprises 3D refractive index images of the cell.

7. The system according to claim 1, wherein the trained neural network comprises: a trained encoder neural network being one of the following: long short-term memory (LSTM), recurrent neural network (RNN), gated recurrent unit (GRU); and a decoder neural network.

8. The system according to claim 7, wherein said decoder neural network is a generative adversarial network (GAN).

9. The system according to claim 1, wherein said trained neural network model is configured to implement a convolution neural network (CNN) functionality.

10. An imaging flow cytometer system comprising: an imaging module configured and operable for providing raw measured data comprising measured data pieces corresponding to a stream of wavefront acquisitions collected from said biological cell being obtained from the cell during the fast flow, and the data analysis system according to claim 1.

11. A method for use in inspecting biological cells during fast flow, the method comprising:
providing trained neural network configured for translating a stream of wavefront acquisitions collected from a flowing biological cell into a predetermined cell-related data;
providing input data comprising raw measured data in the form of measured data pieces corresponding to a stream of wavefront acquisitions of the biological cell under inspection being obtained from said biological cell during the fast flow;
performing real time processing of said raw measured data by accessing said trained neural network and applying to said raw measured data a trained neural network model and extracting cell-related data.

12. The method according to claim 11, wherein said raw measured data comprises the data pieces corresponding to the stream of digital holograms.

13. The method according to claim 11, wherein the cell-related data includes a cell type, enabling direct classification of the cell based on the analysis of the raw measured data.

14. The method according to claim 11, wherein the cell-related data extracted from the raw measured data collected from a rotating biological cell being inspected during the fast flow is indicative a three-dimensional structure of the cell and contents of the cell, thereby enabling direct visualization of the biological cell.

15. The method according to claim 11, wherein said providing of the trained neural network comprises processing a trained set of raw measured data comprising wavefront acquisitions of collected from a similar biological cell during the fast flow and corresponding cell-related data.

16. The method according to claim 15, wherein said corresponding cell-related data is indicative of 3D refractive index images of the cell obtained via full OPD-based reconstruction of said wavefront acquisitions.

17. The method according to claim 11, wherein the trained neural network comprises: a trained encoder neural network being one of the following: long short-term memory (LSTM), recurrent neural network (RNN), gated recurrent unit (GRU); and a decoder neural network.

18. The method according to claim 17, wherein said decoder neural network is generative adversarial network (GAN).

19. The method according to claim 11, wherein said trained neural network model is configured to implement a convolution neural network (CNN) functionality.

20. The method according to claim 11, wherein the biological cell being imaged is unstained.
